(19) United States
(12) Patent Application Publication
(10) Pub. No.: US 2009/0148724 A1
(43) Pub. Date: Jun. 11, 2009

(54) Glass Substrate for Magnetic Recording Medium and Magnetic Recording Medium

(75) Inventors: Kazuyuki Haneda, Chiba (JP); Katsuaki Aida, Chiba (JP); Hiroyuki Machida, Chiba (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Tokyo (JP)

(21) Appl. No.: 11/660,910

(22) PCT Filed: Aug. 29, 2005
(86) PCT No.: PCT/JP2005/016158

§ 371 Date: Feb. 23, 2007

Related U.S. Application Data
(60) Provisional application No. 60/607,638, filed on Sep. 8, 2004.

(30) Foreign Application Priority Data
Aug. 30, 2004 (JP) 2004-250996

(51) Int. Cl. G11B 5/62

(52) U.S. Cl. 428/846.9

(57) ABSTRACT

A glass substrate for a magnetic recording medium, having a chamfer face between the surface of the substrate for forming thereon a film comprising a magnetic layer, and the outer peripheral end face (straight face) of the substrate, wherein an R face having a curvature of 0.013 to 0.080 mm is provided between the data face and the chamfer face of the glass substrate.

### CROSS REFERENCE TO RELATED APPLICATION

This application is an application filed under 35 U.S.C. §111(a) claiming benefit pursuant to 35 U.S.C. §119(e) of the filing date of Provisional Application 60/607,638, filed on Sep. 8, 2004, pursuant to 35 U.S.C. §111(b).

### TECHNICAL FIELD

The present invention relates to a magnetic recording medium which is widely usable as a recording medium in various electronic devices (e.g., computer), and a glass substrate which is suitably usable as a substrate (or base material) for forming the above-mentioned magnetic recording medium.

### BACKGROUND ART

Heretofore, an aluminum substrate has been widely used as the substrate for magnetic recording mediums such as magnetic disk (e.g., hard disk). On the other hand, in recent years, various electric appliances such as small personal computer and portable audio-video recording/reproducing apparatus have been widespread. In addition, to cope with the tendency toward so-called light, thin, short and small weight, size or volume in these electric appliances, the demand for thinning, high-density recording and applicability in various use environments of a magnetic recording medium which is one of the important components constituting the electric appliance is more and more increasing.

In order to satisfy this severe requirement, a glass substrate having high impact resistance, rigidity/hardness and high chemical durability has come to be widely used in recent years. When such a glass substrate is used for a magnetic recording medium in the hard disk (HD) mode, this is generally advantageous also in that flatness suitable for low flying of the head on the magnetic recording surface, which is very important for realizing a high-density magnetic recording surface, can easily be obtained.

More specifically, in the field of substrate for a magnetic disk, thinning by the reduction in weight and mechanical properties such as rigidity high enough to endure rolling of the disk at high-speed rotation are required and at the same time, the demand for high-density recording is very strong. The flying height of the magnetic head with respect to the magnetic disk substrate is becoming extremely small so as to achieve high-density recording and for the purpose of achieving extremely small flying height, the magnetic disk substrate is required to have specular flatness or small surface roughness and at the same time, have least possible defects such as fine scratch and fine pit.

On the other hand, in the recording/reproduction by the hard disk, as well known, various errors (e.g., recording/reading error at recording/reproduction, crash of head) may occur.

For the purpose of reducing these various errors, the glass substrate shape is variously specified to decrease particle (fine particulate substance) or the like which may be produced on the disc (see, Patent Documents 1 and 2).

However, when the head-to-disc distance is made small so as to attain high-density recording (for example, about 10 μm or less), the above-mentioned errors tend to be further increased.

[Patent Document 1] JP-A (Japanese Unexamined Patent Publication; KOKAI) No. 2002-100031

[Patent Document 2] JP-A No. 2002-342915

### DISCLOSURE OF INVENTION

An object of the present invention is to provide a recording medium capable of overcoming those drawbacks in prior art, and a glass substrate suitably usable for such a medium.

Another object of the present invention is to provide a magnetic recording medium capable of decreasing errors even when the head-to-disc distance is further reduced to attain high-density recording, and a glass substrate suitably usable for such a medium.

As a result of earnest study, the present inventors have found that it is very effective for achieving the above-mentioned objects to provide an “R face” having a specific curvature between the data face and the chamfer face of the glass substrate.

The glass substrate for a magnetic recording medium according to the present invention is based on the above discovery. More specifically, the glass substrate for a magnetic recording medium according to the present invention has a chamfer (chamfered) face between the surface (data face) of the substrate for forming thereon a film comprising a magnetic layer, and the outer peripheral (or circumferential) end face (straight face) of the substrate, wherein an R face having a curvature of 0.013 to 0.080 mm is provided between the data face and the chamfer face of the glass substrate.

The present invention also provides a magnetic recording medium, comprising: the above-mentioned glass substrate, and a magnetic recording layer disposed on the data face of the glass substrate.

The present invention includes, for example, the following embodiments.

(1) A glass substrate for a magnetic recording medium, having a chamfer (chamfered) face between the surface (data face) of the substrate for forming thereon a film comprising a magnetic layer, and the outer peripheral end face (straight face) of the substrate, wherein an R face having a curvature of 0.013 to 0.080 mm is provided between the data face and the chamfer face of the glass substrate.

(2) A magnetic recording medium, comprising: a glass substrate according to the above item (1), and a magnetic recording layer disposed on the data face of the glass substrate.

When the glass substrate for a magnetic recording medium or the magnetic recording medium according to the present invention having the above-mentioned structure or constitution is used, an effect of decreasing errors is obtained. According to the knowledge of the present inventors, the reason therefore may be presumed as follows.

In various production steps for producing a glass substrate for a magnetic recording medium, a large number of sheets of the substrate material are, for example, transported or stored by placing the sheets in a predetermined cassette (usually made of a resin) in many cases. When an acute shape is remaining between the data face and the chamfer face of the substrate material, a particle or particles are produced due to rubbing with the cassette at the time of taking the substrate material in and out the cassette, and this particle can adhere to HD produced from the substrate, so as to cause various errors.

In the present invention, an “R face” having the above-mentioned specific curvature is provided between the data face and the chamfer face of the glass substrate, and in such a case, according to the experiments by the present inventors, it is presumed that the above-mentioned “rubbing” is decreased or eliminated and various errors of HD are also decreased.

### BRIEF DESCRIPTION OF DRAWINGS

FIG. 1 is a schematic perspective view and a schematic sectional view each showing a basic embodiment of the glass substrate according to the present invention.

FIG. 2 is an enlarged schematic sectional view of the basic embodiment of the glass substrate of FIG. 1.

FIG. 3 is a schematic sectional view showing a method for measuring the curvature of corner R in the present invention.

FIG. 4 shows photographs showing test methods used in Examples appearing hereinafter.

FIG. 5 shows SEM photographs and data showing test results obtained in Examples appearing hereinafter.

### BEST MODE FOR CARRYING OUT THE INVENTION

Hereinbelow, the present invention will be described in more detail, with reference to the accompanying drawings, as desired. In the following description, “%” and “part(s)” representing quantitative proportions or ratios are those based on mass, unless otherwise specifically noted.

### (Glass Substrate)

The glass substrate according to the present invention has a chamfer (chamfered) face between the surface (data face) of the substrate for forming thereon a film comprising a magnetic layer, and the outer peripheral end face (straight face), and has an R face having a curvature of 0.013 to 0.080 mm between the data face and the chamfer face of the glass substrate.

### (One Basic Embodiment)

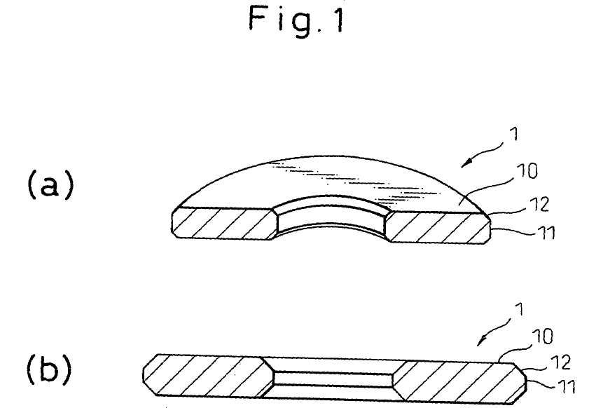

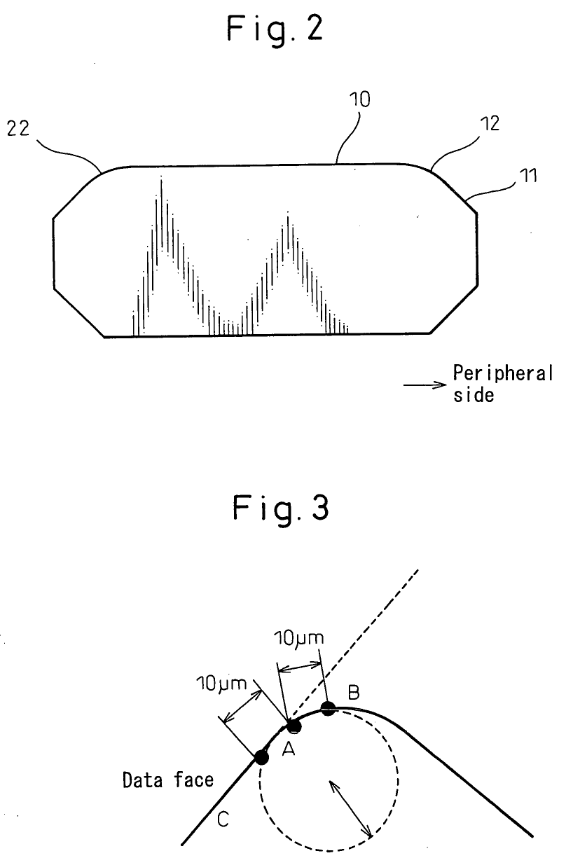

FIG. 1(a) is a schematic perspective view showing one basic embodiment of the glass substrate according to the present invention, and FIG. 1(b) is a schematic sectional view thereof. FIG. 2 is an enlarged sectional view of this embodiment.

Referring to FIGS. 1 and 2, in the glass substrate according to the present invention of this embodiment, an R face 12 having a specific curvature is provided between the data face 10 and the chamfer face 11. In FIG. 2, R faces 12 and 22 are provided on both of the outer peripheral face and the inner peripheral face. According to the experiments by the present inventors, it has been found that the R face 12 on the outer peripheral face has a larger effect. Therefore, in the present invention, it is sufficient that an R face 12 is provided at least on the outer peripheral face (of course, both of R faces 12 and 22 may preferably be provided).

### (R Face)

The “R face” as used in the present invention means a face at the boundary between the data (recording) face and the chamfer face. The size (length along the cross-section) of this R face may be preferably on the order of 0.06 to 0.100 mm.

### (Curvature)

In the present invention, the curvature of the R face 12 is from 0.013 to 0.080 mm (preferably from 0.03 to 0.07 mm). This curvature can be suitably measured by the method described later in Test Example 1.

If the curvature is less than 0.013 mm, the effect attributable to the “R face” is insufficient, whereas if the curvature exceeds 0.080 mm, the end part shape such as dub-off changes for the worse (the “dub-off” as used herein is also called “edge sagging” and described, for example, in International Publication WO-01/23485).

### (Glass Material)

The glass substrate for a magnetic disk is attracting attention as a substrate capable of coping with high rigidity and thinning and moreover, making use of the merits such as high impact resistance. The glass material for the substrate is roughly classified into a chemically strengthened glass and a crystallized glass. In either case, the glass material is subjected to a strengthening treatment or a crystallization treatment so as to overcome the defect inherent in the glass, that is, brittleness.

Usually, the presence of a scratch on the glass surface greatly impairs the mechanical strength and from the standpoint of enhancing the disk reliability, a chemically strengthening treatment by ion exchange is applied. More specifically, the glass substrate (original plate) is dipped in an alkali fused salt, and the alkali ion on the glass surface is exchanged with a larger ion in the fused salt, whereby a compression stress strain layer is formed on the glass surface layer and the breaking strength is greatly increased. In the thus chemically strengthened glass substrate, alkali is prevented from dissolving out from the inside of glass. Preferred examples of the glass substrate for HD include an aluminosilicate glass substrate containing Li⁺ and Na⁺, a soda lime glass substrate containing K⁺ and Na⁺, and a crystallized glass.

### (Suitable Glass Material)

The glass material suitably usable in the present invention is not particularly limited, as long as the R face having a specific curvature can be formed.

In the present invention, the crystallized glass and the strengthened glass both can be suitably used irrespective of the kind of glass. For example, the glass material includes a series of materials called “glass ceramics”, and examples of the commercially available product include the glass ceramic (TS-10X, trade name) produced by OHARA Inc.

### (Process for Producing Glass Substrate)

The process for producing the glass substrate usable in the present invention is not particularly limited, as long as the R face having a specific curvature can be formed by the process.

### (Magnetic Recording Medium)

The magnetic recording medium according to the present invention is obtained by disposing a magnetic recording layer on the data face of the above-mentioned glass substrate according to the present invention. The method for forming the magnetic recording layer is not particularly limited, as long as the effect of the glass substrate having an R face with a specific curvature of the present invention is not substantially inhibited.

Hereinbelow, the present invention will be described in more detail with reference to Examples.

### EXAMPLES

### Test Example 1

### (Measurement of Curvature)

The curvature was measured by using a commercially available measuring apparatus “CONTRACER” (CONTRACER CP400, trade name, manufactured by Mitsutoyo Corporation). The measuring conditions used here were as follows.

### <Measuring Conditions>

Speed: 0.06 mm/s

Pitch: 0.0010 nm

Mode: X-axis fixing

### <Measuring Method>

As shown in the schematic sectional view of FIG. 3, an extension line of the recording face (data face) of the glass substrate is drawn and the position where the shape curve for the R face separates from the extension line due to the curvature based on the R face of the glass substrate is designated as Point A. The positions 10 μm distant from Point A are designated as Point B and Point C. A circle passing through these Points A, B and C is determined and the radius of this circle is defined as the “curvature”.

### Example 1

The portion between the data face and the chamfer face was polished to obtain a glass substrate having an R face with a curvature of 0.038. The characteristic properties of each glass substrate were measured as follows.

### Test Method 1:

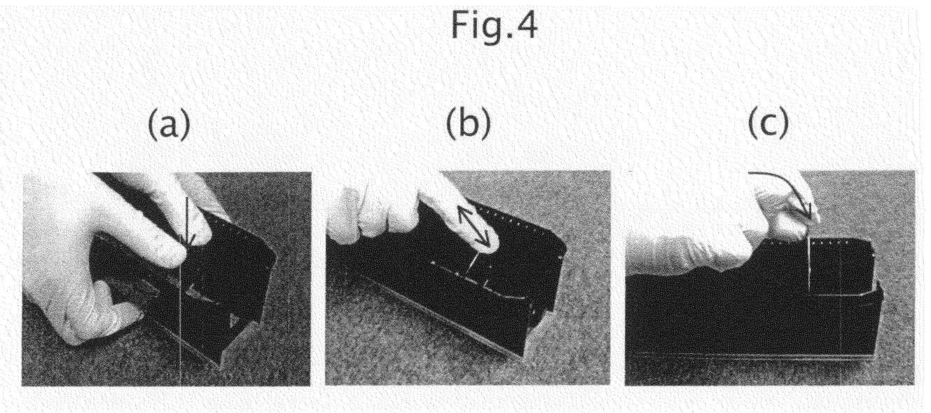

As shown in FIG. 4(a), the glass substrate sample to be tested was held in a hand and lightly pressed to the top cover of a commercially available cassette (made of resin, S800-65TSJ, trade name, manufactured by Floroware, Inc.).

### Test Method 2:

As shown in FIG. 4(b), the substrate was placed in the cassette and after fixing thereto top and bottom covers, the glass substrate sample was reciprocated 10 times along the vertical direction to rub the glass substrate sample on the cassette.

### Test Method 3:

As shown in FIG. 4(c), the glass substrate sample was disposed in the housing groove of the cassette.

Each of the samples tested above was measured on the contamination by the following method.

### <Method for Measuring Contamination>

Respective outermost peripheral parts of the chamfer face and the data face were observed by an optical microscope at a magnification of 400 and the actual number of observed particles was counted.

The glass substrate which had not been polished in the manner of Example 1 was used as the sample of Comparative Example.

### Example 2

A glass substrate (the portion between data face and chamfer face was 45° straight face) and the glass substrate of Example 1 (the portion between data face and chamfer face was R face with a curvature of 0.038 mm) were observed in the cross-section by SEM (scanning electron microscope) (S4700, trade name, manufactured by Hitachi Ltd., magnification: 500) and summarized in combination with the contamination measurement results of Example 1 above.

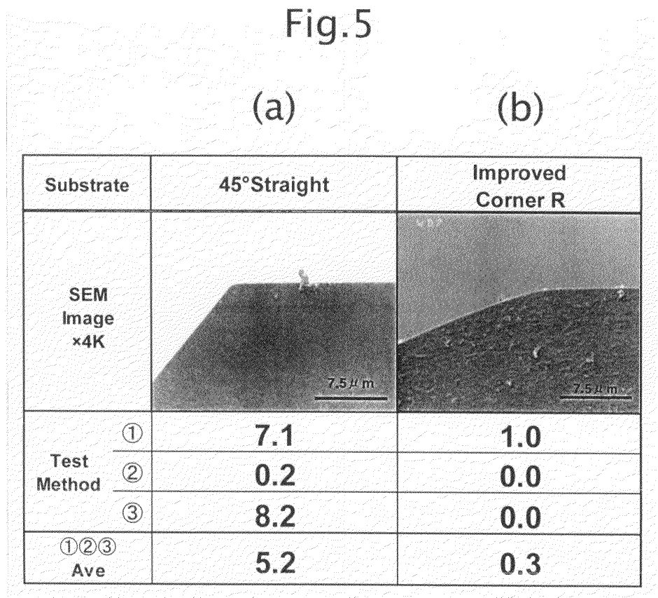

As seen from the results of comparison in FIG. 5, the glass substrate having a specific R face according to the present invention is mostly free from the generation of contamination.

### INDUSTRIAL APPLICABILITY

As described above, the present invention provides a magnetic recording medium capable of decreasing errors even when the head-to-disc distance is further reduced in order to attain high-density recording. The present invention also provides a glass substrate suitably usable for such a medium.

1. A glass substrate for a magnetic recording medium, having a chamfer (chamfered) face between the surface (data face) of the substrate for forming thereon a film comprising a magnetic layer, and the outer peripheral end face (straight face) of the substrate,
wherein an R face having a curvature of 0.013 to 0.080 mm is provided between the data face and the chamfer face of the glass substrate.

2. A magnetic recording medium, comprising:
a glass substrate according to claim 1, and
a magnetic recording layer disposed on the data face of the glass substrate.
